(19) United States
(12) Patent Application Publication
(10) Pub. No.: US 2005/0252532 A1
(43) Pub. Date: Nov. 17, 2005

(54) Method and system for washing

(76) Inventors: Peter Gerard Gray, Newcastle Upon Tyne (GB); Graeme Duncan Cruickshank, Newcastle Upon Tyne (GB); Adam Costello, North Tyneside (GB); Michael Duncan, Terrace Park, OH (US); John Christian Haught, West Chester, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/967,757

(22) Filed: Oct. 18, 2004

(30) Foreign Application Priority Data
May 17, 2004 (EP) 04252845.5

(51) Int. Cl. B08B 3/00

(52) U.S. Cl. 134/25.2; 134/26; 134/34; 134/58 D; 134/111; 134/200; 8/158; 68/13 A

(57) ABSTRACT

A washing system for use in cleaning or washing a substrate comprising: a washing zone capable of containing a substrate; and a water-softening zone.

### CROSS REFERENCE TO RELATED APPLICATION

This patent application claims the benefit of co-pending European Application Serial No. 04252845.5 filed May 17, 2004 to Grey, et al.

### BACKGROUND OF THE INVENTION

In recent years there has been growing interest in a variety of non-detergent based technologies for washing laundry and other soiled substrates. For example, a number of washing machines have been launched on the Japanese and Asian markets that make use of electrolysis, ultrasonic or cavitation techniques to promote the cleaning or disinfection of laundry. Typically, such machines include at least one wash cycle characterized as ‘detergent-free’ and which is designed for the washing of laundry that is relatively lightly soiled. As the washing machine manufacturers themselves make clear, however, the machines and systems currently on the market are of limited value for the washing of more heavily soiled or stained items where the use of a surfactant-based detergent product continues to be necessary to achieve acceptable cleaning performance. Accordingly, such machines are designed and marketed for so-called ‘hybrid’ use with non-detergent and detergent wash-cycles being selectable according to the severity of the laundering task.

In terms of overall resource utilization, the non-detergent based cleaning technologies may have the potential to save on detergent product usage in light soil situations, but such savings are offset to a lesser or greater extent by the operational need for higher water and energy utilization. Thus the resource equation is finely balanced.

It clearly would be desirable to enhance the efficacy of current washing machines and systems, including the newer ‘hybrid’ machines, so as to deliver improved washing performance across the full range of detergent usage levels. It would also be desirable to deliver performance improvements in the context of an overall efficient and sustainable utilization of resources—chemical, water and energy.

It is an object of the present invention to provide methods and systems applicable in the field of domestic or institutional appliances such as laundry washing machines, automatic dishwashing machines, etc and which enable improved cleaning of a soiled substrate or substrates across the range of detergent usage levels. It is a further object of the invention to provide washing methods and systems enabling more efficient usage of water, energy and detergent product resources.

### SUMMARY OF THE INVENTION

In one embodiment the present invention includes a washing system for use in cleaning or washing a substrate comprising: washing zone capable of containing a substrate; and a water-softening zone fluidly connected to the washing zone; wherein the water-softening zone is capable of receiving a feed water and forming an at least partially softened water and wherein the water-softening zone is capable of fluidly transferring at least part of the at least partially softened water to the washing zone. In another embodiment, the washing zone is capable of cleaning or washing substrates comprises laundry and dishware. In yet another embodiment, the water-softening zone comprises nanofiltration devices, electrodeionization devices, electrodialysis devices, reverse-osmosis devices capacitive deionization devices, and ion-exchange water-softening devices and combinations thereof. In still another embodiment, the water-softening zone is a capacitive deionization device.

In one embodiment, the at least partially softened water comprises a residual Ca²⁺ hardness of less than about 4 mmol/L. In another embodiment, the at least partially softened water comprises a soft water flux of at least about 2 L/h at a feed water pressure from about 100 to about 1000 kP.

In one embodiment, the washing system further-comprising at least one of a washing pre-treatment zone fluidly connected to the washing zone; a sonic treating zone or an ultrasonic treating zone, each capable of treating a substrate in the washing zone or in the washing pre-treatment zone; and an electrolysis zone capable of electrolyzing the feed water or the at least partially softened water fluidly connected to the washing zone.

In one embodiment, the washing zone is capable of utilizing a detergent. In another embodiment, the washing zone and the water-softening zone are housed substantially within one housing. In yet another embodiment, the washing zone and the water-softening zone are independently housed. In still another embodiment, the washing system further comprises a prefilter.

In one embodiment, the present invention includes a process for cleaning or washing a substrate comprising the steps of: providing a washing system, said system comprising a washing zone capable of containing a substrate; and a water-softening zone fluidly connected to the washing zone; wherein the water-softening zone is capable of receiving a feed water and forming an at least partially softened water and wherein the water-softening zone is capable of fluidly transferring at least part of the at least partially softened water to the washing zone, placing a substrate with the washing system; flowing the feed water into the water-softening zone; engaging the water-softening zone to form the at least partially softened water; transferring at least part of the at least partially softened water into the washing zone and optionally, adding a detergent to the washing zone.

In one embodiment, the washing zone is capable of cleaning or washing substrates selected from laundry or dishware. In another embodiment the water softening zone comprises nanofiltration devices, electrodeionization devices, electrodialysis devices, reverse-osmosis devices capacitive deionization devices, and ion-exchange water-softening devices and combinations thereof. In another embodiment, the water-softening zone is a capacitive deionization device.

In one embodiment, the at least partially softened water comprises a residual Ca²⁺ hardness of less than about 4 mmol/L.

In one embodiment, the washing system further comprising at least one of a washing pre-treatment zone fluidly connected to the washing zone; a sonic treating zone or an ultrasonic treating zone, each capable of treating a substrate in the washing zone or in the washing pre-treatment zone; and an electrolysis zone capable of electrolyzing the feed water or the at least partially softened water fluidly connected to the washing zone.

In one embodiment, the present invention includes washing system for use in cleaning or washing a substrate comprising: a washing zone capable of containing a substrate; and a water-softening zone, and an electrolysis zone wherein the water-softening zone is capable of directing at least a partially softened water to the washing zone, the electrolysis zone, or combinations thereof, and wherein the water-softening zone is capable of directing a waste electrolyte stream to the electrolysis zone, and wherein the electrolysis zone is capable of directing an acid stream and/or a base stream to the washing zone, the water-softening zone or combinations thereof.

In one embodiment, the water-softening zone is a capacitive deionization unit. In another embodiment, the acid stream is fluidly connected to the water-softening zone. In yet another embodiment, the waste electrolyte stream is fluidly transported to the water-softening zone.

### DETAILED DESCRIPTION OF THE INVENTION

While the specification concludes with the claims particularly pointing and distinctly claiming the invention, it is believed that the present invention will be better understood from the following description.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages and ratios used herein are by weight of the total composition and all measurements made are at 25° C., unless otherwise designated. An angular degree is a planar unit of angular measure equal in magnitude to 1/360 of a complete revolution.

All measurements used herein are in metric units unless otherwise specified.

The term “product” as used herein encompasses both active-based detergent compositions suitable for washing and cleaning of soiled substrates as well as auxiliary compositions suitable for use after washing or in conjunction with active-based detergents and designed to provide an ancillary substrate benefit or effect, for example, finishing agents, rinsing agents, fabric enhancers designed to provide post-wash fabric care benefits, and detergent auxiliaries designed to provide post-wash surface care benefits. The terms “product dispensing zone,” “product storage means,” etc., should be construed accordingly.

The term “feed water” as used herein encompasses water directly from the mains including municipally available water and ground water, from the mains or used-water reservoir such as a recycle reservoir used for storage of recycled water, a storage tank, or from a combination thereof.

The term “laundry” as used herein encompasses woven and non-woven fabric. Non-limiting uses for this fabric include clothing, bedding, towels, and the like.

The term “dishware” as used herein encompasses implements for eating, cooking, serving and the like including, but not limited to, dishes, pots, pans, flatware, cups, glassware, and the like.

It has now surprisingly been discovered that the washing system of the present invention provides increased cleaning and washing efficacy. Further, the washing systems can be utilized for a variety of cleaning or washing duties. According to a first aspect of the present invention, there is provided a washing system for use in cleaning or washing a soiled substrate or substrates, the system comprising a washing zone capable of containing a substrate; a water-softening zone fluidly connected to the washing zone. The water-softening zone is capable of receiving a feed water and forming an at least partially softened water. The water-softening zone is also capable of fluidly transferring at least part of the at least partially softened water to the washing zone. Optionally, the washing system can also include one or more of the following: a product dispensing zone (sometimes referred to herein as ‘the dispensing zone’); means for sonically or ultrasonically treating the soiled substrate in the washing zone or in a washing pre-treatment zone; an electrolysis zone for electrolysing the feed water or wash liquor; and a wash liquor disinfection zone. The washing zone can be dual purpose and also function as a post-wash rinsing zone; alternatively the wash system can optionally comprise a separate post-wash rinsing zone.

In one embodiment, it is contemplated that the washing systems of the present invention are contained substantially within one housing. Without wishing to be bound by theory, it is believed that by housing the washing systems of the present invention substantially within one housing minimises any plumbing or fluid connections necessary among the elements of the washing system. Also, housing the washing systems of the present invention substantially within one housing minimizes the volume and/or space required by the washing systems of the present invention.

In another embodiment, it is contemplated that the washing zone and the water softening zone are independently housed. Such an embodiment is contemplated with washing systems that are at the point-of-use. In one non-limiting example, it is contemplated that the water-softening zone of the present invention is located in a different housing than the washing zone. The water-softening zone is fluidly connected between the inlet water stream and the inlet of the washing zone. In such an embodiment, its is contemplated that existing devices utilizing feed water, including washing zones comprising washing machines and automatic dishwashing machines, water heaters, as well as “whole-house” inlet streams may be retrofitted and/or adapted to have such water softening zones present to treat feed water.

Water-Softening Zone

According to the invention, the washing systems herein comprise a water-softening zone. In the systems and methods of the invention, the water-softening zone comprises one or more devices selected from nanofiltration, electrodeionization, electrodialysis, reverse-osmosis, ion-exchange, and capacitive deionization water-softening devices and combinations thereof. In one embodiment, the water-softening zones can include those disclosed in the commonly-assigned and co-filed patent application in the name of Baeck, Convents and Smets, applicant's reference number CM2849F, said application being incorporated by reference herein and described in detail below.

In one embodiment, the water softening zone is effective to soften the water to a residual Ca²⁺ hardness of less than about 4 mmol/L, in another embodiment less than about 2 mmol/L, in yet another embodiment less than about 1 mmol/L, in still another embodiment from about 4 mmol/L to about 0.01 mmol/L, in yet still another embodiment from about 2 mmol/L to about 0.05 mmol/L, in even still another embodiment from about 1 mmol/L to about 0.1 mmol/L.

It is, however, well known that technologies for increasing water softness will remove ionic species, including, but not limited to cationic species, anionic species, zwitterionic species, amphoteric species and combinations thereof. Such cationic species include, but are not limited to, calcium, iron, magnesium, manganese, sodium and mixtures thereof. Such anionic species include, but are not limited to, chlorine, fluorine, carbonate and mixtures thereof.

Downstream of the water-softening zone and in fluid communication therewith, the washing system can additionally comprise an softened water reservoir for storing and delivering at least partially softened water to the washing zone.

Without wishing to be bound by theory, it is believed that the water-softening zone forms an at least a partially softened water. The partially softened water, when transferred to the washing zone, increases the efficacy of any product added to the washing zone. Further, it is believed that the at least partially softened water lengthens the usable life of components of the washing system, as the use of at least partially softened water reduces and/or prevents the build up of hard water deposits, scales, and the like resulting in cleaner washing system components.

Capacitive Deionization

In another embodiment, the water-softening zone utilizes capacitive deionization. Capacitive deionization units utilize charged electrodes for softening of the water. Capacitive deionization with electrodes is capable of removing ionic species and other impurities from water. Without wishing to be bound by theory, water is passed between electrodes kept at a low potential difference and/or voltage. When the electrodes become saturated with ionic species, the electrodes are electrostatically regenerated, and ionic species are expelled as a waste electrolyte stream. The electrodes are periodically purged of ionic species by reversing electrode polarity and flushing with water. Further, the electrodes can be regenerated of adsorbed materials by contacting the electrodes with acid streams or base streams. In one embodiment, acid streams and base streams are generated by an electrolysis zone, as discussed herein.

In one embodiment, the electrodes of the capacitive deionization units are made from carbon aerogels. Exemplary carbon aerogel electrodes are found in U.S. Pat. No. 6,309,532 to Tran et el. Carbon-aerogel electrodes have excellent chemical stability and a very high surface area.

In one embodiment, carbon aerogels are made utilizing various carbon systems. These systems are often, though not necessarily made by pyrolisis. These carbon systems include, but are not limited to, resorcinol/formaldehyde resorcinol/phenol/formaldehyde, hydroquinone/resorcinol/formaldehyde, phloroglucinol/resorcinol/formaldehyde, catechol/resorcinol/formaldehyde, polyvinyl chloride, phenol/formaldehyde, epoxidized phenol/formaldehyde, polyvinyl chloride, phenolibenzaldehyde, oxidized polystyrene, polyfurfuryl alcohol, polyvinyl alcohol, polyacrylonitrile, polyvinylidene chloride, cellulose, polybutylene, cellulose acetate, melamine/formaldehyde, polyvinyl acetate, ethyl cellulose, epoxy resins, acrylonitrile/styrene, polystyrene, polyamide, polyisobutylene, polyethylene, polymethylmethacrylate, polyvinyl chloride/divinylbenzene, divinylbenzene/styrene, and combinations and mixtures thereof.

Other sources can be utilized for form electrodes for use in capacitive deionization units. In one embodiment, electrodes exemplified are U.S. Pat. No. 6,737,445 to Bell et al. and U.S. Application No. 20030153636 to Dietz et al. are utilized. Further, the electrodes may be arranged in a flow through fashion, as described in U.S. Pat. No. 6,462,935 to Shiue et al. and U.S. Application No. 20040095706 to Faris et al.

In one embodiment, the flow rate of feed water treated with capacitive deionization to make an at least partially softened water is from about 0.5 liters/min to about 20.0 liters/min, in another embodiment from about 0.75 liters/min to about 8 liters/min, in yet another embodiment from about 1 liters/minute to about 5 liters/min, in still another embodiment greater than about 1 liter/minute.

In one embodiment, the overall surface area of the electrodes utilized in the capacitive deionization unit is from about 200 to about 1500 m²/g; in another embodiment from about 400-1200 m²/g; in another embodiment from about 500-1000 m²/g.

In one embodiment the potential difference or voltage is from about 0.5 volts to about 10 volts; in another embodiment from about 0.75 to about 8 volts; in yet another embodiment from about 1 to about 5 volts.

In one embodiment, the capacitive deionization unit is capable of self-cleaning. In one self-cleaning embodiment, cleaning commences when the electrodes exhibit diminished adsorption of the ionic species from the solution as noted by the increase in the resistance across the electrode and a decrease in the level of hardness reduction. In one embodiment, the decreased performance of the electrodes is observed by a conductivity meter. One of ordinary skill in the art would readily be able to determine means of measuring the decrease in performance of the electrodes of the present invention. The decreased performance, in one embodiment, is measured by dividing the conductivity of the “dirty” electrode by the conductivity of the “clean” electrode to determine the conductivity fraction. When the conductivity fraction reaches a predetermined value, a self-cleaning cycle is initiated. In one embodiment, a self-cleaning cycle is initiated when the conductivity fraction is less than about 0.9, in another embodiment, the conductivity fraction is less than about 0.7, in yet another embodiment, the conductivity fraction is less than about 0.5.

Optionally, the capacitive deionization unit further comprises a prefilter. Without wishing to be bound by theory, it is believed that the prefilter is capable of extending the life of the electrodes, as well as delaying the frequency of the self-cleaning cycle of the electrodes. It is believed that the prefilter absorbs, blocks, or otherwise removes the neutrally charged species contained in feed water. Such neutrally charges species are minimally effected by the electrodes on the capacitive deionization unit and thus are capable of contaminating the adsorption sites on the electrodes. The prefilter of the present invention is made from any material that substantially absorbs, blocks, and/or otherwise removes neutrally charged species from feed water. Such materials include, but are not limited to, activated carbon, silica, paper, metallic mesh filters, membranes, gels, and combinations thereof.

Nanoffitration

In another embodiment, the water-softening zone comprises a feed water filtration device. One type of filtration device is a nanofiltration device having a cut-off in the range from about 100 to about 1000 Daltons, preferably from about 200 to about 1000 Daltons. The clean water flux of the device, on the other hand, is preferably at least 3, more preferably at least 6 L/m²h at 100 kP at 25° C. The device preferably has a magnesium ion rejection of at least 50%, more preferably at least 80% (0.35 wt % MgSO₄, 600 kP, Re=2500, 25° C.).

In yet another embodiment, the water-softening zone takes the form of a cross-flow filtration device having permeate and retentate outlet ports, the permeate outlet port being in fluid communication with the washing zone and the retentate outlet port being in fluid communication with one or more of the effluent storage, discharge and wash liquor-cleanup and recycle zones.

In still another embodiment, cross-flow devices are provided with a feed water input, retentate recirculation, hard-water effluent bleed and optional recirculation pump. In one embodiment, the flux ratio of soft-water permeate to hard-water effluent is at least about 1:1, In another embodiment at least about 3:1, in yet another embodiment at least about 5:1, and in still another embodiment at least about 8:1.

Such filtration devices preferably take the form of a module comprising a filter housing provided with a membrane compartment in which is mounted a bundle of capillary or tubular filtration membranes, the ends of which are encased in membrane holders and which communicate with one or more inlet ports and one or more retentate outlet ports. The filter housing is also provided with one or more openings in the wall of the filter housing and which communicate with one or more permeate outlet ports. Hot or cold water from the feed supply enters the filter housing via a connection into the inlet port and then passes through the capillary or tubular filtration membranes, the resulting retentate and permeate being discharged through connections into the corresponding retentate and permeate outlet ports. Such an arrangement is referred to herein as an ‘inside-out’ arrangement.

Alternatively, the module can be operated in reverse manner (‘outside-in’) wherein the feed water is supplied and the retentate discharged via openings in the wall of the filter housing communicating with corresponding inlet and retentate outlet port connections. In this case permeate is collected within the filtration membranes and discharged via their open ends and corresponding permeate outlet port connections.

The module can also be provided with one or more distributor pipes placed transverse to the direction of the filtration membranes with one or more openings into the membrane compartment in order to reduce the transverse forces on the filtration membranes, such an arrangement being described in detail in WO-A-98/20962.

Exemplary filtration devices or modules include polyamide/polyethersulfone nanofiltration membranes developed for inside-out filtration marketed by X-Flow B.V. under the designation NF50M10.

Nanofiltration membranes can be prone to degradation or attack by chlorine in feed water. Accordingly the filtration device may be used in conjunction with a chlorine removal system such as a carbon prefilter, an antioxidant or brass in order to extend the working life of the device.

In filtration device embodiments, the filtration device preferably also comprises a pump for recirculating the retentate stream through the filtration module under elevated pressure, the pump either being situated in the recirculation loop with the sole or primary purpose of retentate recirculation or else being operatively connected to the main discharge pump of the washing appliance or washing zone.

Electrodialysis/Electrodeionization

In yet another embodiment, the water-softening zone comprises an electrodialysis or electrodeionization device. In electrodialysis, cation-exchange membranes are alternatively stacked with anion-exchange membranes and the resulting compartmentalized array is placed between two oppositely-charged electrodes. Feed water is fed into the device under low pressure and circulated between the membranes. On application of direct current to the electrodes, cations and anions move in opposite directions towards the cathode and anode respectively and concentrate in alternate compartments. The at least partially softened water from the device is then fed to the washing zone and the hard water effluent fed to one or more of the effluent storage, discharge and wash liquor-cleanup and recycle zones.

Electrodeionization is in effect a combination of electrodialysis with ion exchange. In this case a mixture of cation- and anion-exchange resins are introduced between the cation- and anion-exchange membranes and all ionic species in the feed water are trapped within the resin. The at least partially softened water output is then fed to the washing zone whereupon the device undergoes an electrochemical regeneration cycle in which the cation- and anion-exchange resins are regenerated for subsequent use. The resulting the hard water effluent is then fed to one or more of the effluent storage, discharge and wash liquor-cleanup and recycle zones.

The washing systems of the invention can take the form of an integral water-softening and washing appliance wherein the water-softening zone and washing zone are built into and form part of a single appliance with the two zones in fluid communication with one another via the conduits of the appliance. In another embodiment, the washing system comprises a water-softening appliance and a washing appliance in hyphenated form, whereby the water-softening appliance and its associated water-softening zone forms a stand-alone unit that can be either permanently or temporarily fitted to the feed water inlet conduits of the washing appliance as required by the user, any power supply required for the water-softening appliance being taken either from the power supply for the washing appliance or separately from the mains power supply.

Wash Liquor Cleanup

Optionally, the washing system comprises a wash liquor cleanup and recycle zone in fluid communication with the washing zone for purposes of cleaning and recycling the wash liquor. Cleaning of the wash liquor can be performed as a separate batch operation on bulk liquor at an off-line location, but preferably cleaning is performed on a stream of the wash liquor within a recycle loop section of the washing system. Alternatively cleaning can take place within a section or sub-zone of the washing zone itself. The term ‘cleaning’ refers to a reduction in the soil content of the wash liquor (either the bulk liquor or the wash liquor stream as appropriate), soil content being measured, for example, by means of turbidity. Preferably the turbidity of the recycled wash liquor is less than about 15 NTU, more preferably less than about 5 NTU.

After cleaning, the liquor is recycled back to the washing zone where it can be used in the same or a subsequent washing step or in a post-wash rinsing step. In preferred embodiments of this type, the wash liquor is recycled to the washing zone during or at the end of an essentially detergent-free prewash step prior to a detergent-assisted, preferably a bleach-assisted washing step. Prewash embodiments of the invention are particularly valuable herein in the case of bleach-assisted substrate washing steps from the viewpoint of providing improved bleaching and cleaning performance. Preferably, the washing system is arranged to provide continuous or semi-continuous cleanup and recycle of wash liquor during the same substrate washing step, in other words, the wash liquor is recycled continuously or in one or more phases of operation during the washing or prewashing step so as to remove soil from the washing zone and reduce or minimize soil redeposition onto the substrate. By ‘essentially-free’ of detergent is meant a wash liquor containing less than about 0.1% of detergent product by weight of the wash liquor.

In certain systems and methods of the invention the wash liquor cleanup and recycle zone comprises a wash liquor filtration device which is effective to lower the turbidity of the recycled wash liquor to less than about 15 NTU, preferably less than about 5 NTU. The permeate flux delivered by the device, on the other hand, is preferably at least about 100 μl, more preferably at least about 500 L/h when operating at a pressure in the range from about 100 to about 1000 kP (1-10 bar), preferably from about 100 to about 400 kP (1-4 bar). The surface area of the membrane is preferably from about 0.01 to about 2 m², more preferably from about 0.05 to about 1 m², especially from about 0.25 to about 0.75 m².

In other embodiments herein, the wash liquor cleanup and recycle zone comprises an ultrafiltration or microfiltration device. The filtration device preferably has a cut-off in the range from about 1000 Daltons to about 1 μm, more preferably from about 0.05 μm to about 0.5 μm. The filtration device preferably comprises one or more tubular membranes, the lumen size of each membrane being preferably from about 1 to about 10 mm, more preferably from about 2 to about 6 mm, and especially from about 3 to about 5 mm. The filtration device preferably has a clean water flux of at least about 1000 L/m².h. 100 kp (RO water at 25° C.), more preferably at least about 10,000 L/m² at 100 kP. The cut-off herein refers to the nominal pore size rating of the membrane of the device except that the overall minimum value (1000 Daltons) is given in terms of molecular weight cut-off. Lumen size refers to the minimum internal diameter of the membrane.

In one embodiment, the system of the present invention includes a wash liquor cleanup and recycle zone that comprises a cross-flow filtration device. In one embodiment, the cross-flow filtration device comprises one or more free-standing, asymmetric, tubular filtration membranes, each tubular membrane having a lumen size having the dimensions described above. In other embodiments, the device comprises a series of intercommunicating membrane subunits, each subunit being in the form of a bundle comprising one or more, preferably from about 2 to about 20, more preferably from about 5 to about 15 of the tubular filtration membranes. Where the device comprises a plurality of subunits in series, the individual subunits can be interconnected by one or more sections of tubular membrane having a larger lumen size. The total path length of tubular membrane in the device is preferably from about 10 to about 250 m, more preferably from about 35 to about 150 m and the pressure drop from the inlet to the outlet of the device is preferably less than about 2 bar, more preferably less than about 1 bar, and especially from about 0.2 to about 0.5 bar. Furthermore each tubular membrane preferably has a Reynold's Number of at least about 2300, preferably at least about 4000 at an operating pressure in the range from about 100 to about 1000 kP (1-10 bar), preferably from about 100 to about 400 kP (14 bar).

The cross-flow filtration device is provided with wash liquor input and permeate and retentate outlet ports, the permeate outlet port being in fluid communication with the washing zone and the retentate outlet port being in fluid communication with a wash liquor buffer zone or with the effluent discharge zone.

In systems employing a wash liquor buffer zone, wash liquor is fed or drawn from the washing zone to the buffer zone along a first conduit and is then fed under pressure with the aid of a pump along a second conduit from the buffer zone to the inlet port of the cross-flow filtration device. A conventional coarse filter designed to remove particles of greater than about 20 microns, for example activated carbon, can also be provided upstream of the cross-flow filtration device for removal of larger size impurities. The resulting retentate is then recirculated to the buffer zone with permeate being returned to the washing zone. A pressure relief valve can also be provided on the inlet port of the cross-flow filtration device, excess pressure being relieved by drainage into the buffer zone or effluent discharge zone. In one embodiment, the buffer zone is closed to the atmosphere in which case wash liquor is automatically drawn into the buffer zone in tandem with the removal of permeate to the washing zone. Alternatively the buffer zone can be vented to atmosphere and the wash liquor fed under pressure from the washing zone to the buffer zone. Relief valves can also be positioned on the retentate outlet and on the inlet and outlet sides of the buffer zone. A valve, for example a pinch valve, can also be provided on the permeate outlet port of the filtration device to enable intermittent clean-sweeping or back-flushing of the filtration membrane. However, it is a feature of the systems of the invention that they require minimal maintenance in the form of back-flushing or defouling procedures.

The filtration device preferably takes the form of a module comprising a filter housing provided with a membrane compartment in which the tubular filtration membrane or membranes are mounted, the ends of which are encased in membrane holders and communicate with the inlet and retentate outlet ports. Where the device comprises a series of intercommunicating membrane subunits, each subunit generally comprises a bundle of tubular membranes, a pair of membrane holders for encasing the ends of the tubular membranes and an outer sheath provided with one or more openings to allow discharge of permeate into the membrane compartment of the filter housing. The individual membrane subunits can intercommunicate via one or more sections of interconnecting tubular membrane having a lumen size generally greater than that of the individual subunits. The terminal subunits of the series, on the other hand, can communicate with the inlet and retentate outlet ports via one or more sections of tubular membrane and corresponding membrane holders set into the membrane housing. The filter housing is also provided with one or more openings in the wall of the filter housing communicating with the permeate outlet port or ports. Wash liquor enters the filter housing via a connection into the inlet port and then passes through the filtration membrane or membranes, the resulting retentate and permeate being discharged through connections into the corresponding retentate and permeate outlet ports. A wide range of membrane materials can be employed herein for the ultrafiltration or microfiltration device including polypropylene, polyvinylidene difluoride, cellulose acetate, cellulose, polypropylene, polyacrylonitrile, polysulfones, polyarylsulphones, polyethersulphones, polyvinyl alcohol, polyvinyl chloride, polycarbonate, aliphatic and aromatic polyamides, polyimides and mixtures thereof. Preferred herein however is an asymmetric polyethersulphone membrane having a nominal pore size ratio (inner to outer surface) of about 1:10 and a surface energy (inner surface) of about 8 dynes/cm.

Product Dispensing

The washing systems of the invention preferably also comprise a product dispensing zone which in preferred embodiments is situated intermediate the water-softening zone and the washing zone. The product dispensing zone preferably comprises means for dosing product (either an active detergent or a detergent auxiliary such as a finishing agent or fabric enhancer) into the pre-softened feed water within or on the feed water inlet to the washing zone and may also comprise product storage means for bulk detergent and/or detergent auxiliary product. In addition, the product dispensing zone will generally comprise means enabling filling, refilling or replacement of the product storage means and may in addition comprise valves, dispensing orifices or other means for controlling the dosing rate of the detergent and/or detergent auxiliary product relative to the soft water flux of the water-softening zone. Preferably the dispensing and water-softening zones are serially-connected or comprise an integral water-softening and product-dispensing unit, i.e. a unit having separate but interconnected water-softening and product-dispensing zones, the product-dispensing zone being downstream of the water-softening zone and comprising means for dosing product into the feed water on the output side of the water-softening zone.

According to the invention, the wash liquor can be recycled to the washing zone during or at the end of the washing step for use in a subsequent washing step or in a post-wash rinsing step. In a preferred embodiment of this type, the wash liquor is recycled to the washing zone during or at the end of an essentially detergent-free prewash step prior to a detergent-assisted, preferably a bleach-assisted washing step. In such embodiments there can also be included a recycle reservoir for storing the cleaned wash liquor prior to recycling.

Preferably the substrate is contacted with the wash liquor while simultaneously performing cleanup and recycle of the wash liquor. In such embodiments, it can be advantageous to perform cleanup and recycle in one or more phases of operation during the substrate washing step. For example, in one embodiment, cleanup and recycle is initiated in the final half of the washing step, for example, after completion of about 50%, preferably at least about 70% or even about 90% of the washing step. Alternatively cleanup and recycle is initiated only after the system has reached its optimum washing temperature or after the wash liquor has reached a threshold turbidity or conductivity value or a threshold value of soil. For this purpose, the washing system can be provided with one or more sensors responsive to the turbidity, conductivity or soil level of the wash liquor and which acts as a trigger for initiating cleanup and recycle.

In another preferred embodiment which is especially useful for the laundering of fabrics, the wash liquor is recycled to the washing zone or rinsing zone for use in a post-wash rinsing step. Again there can also be included a recycle reservoir for storing the cleaned wash liquor prior to recycling. Preferably the method comprises i) a water softening step wherein the feed water is softened in the water softening zone, ii) an optional detergent dispensing step wherein an active detergent product is dosed in a cleaning-effective amount into the wash liquor or feed water, iii) a washing step wherein the soiled substrate is contacted with the softened wash liquor, iv) the wash liquor cleanup and recycle step, v) a fabric enhancer dispensing step wherein a fabric enhancer providing a post-wash fabric care or aesthetic benefit is dosed into the recycled wash liquor, and
vi) a rinsing step wherein the fabrics are contacted with the resulting rinse liquor. Suitable fabric enhancers include perfumes and other olfactory agents, textile softening agents, ironing aids, antibacterial agents, anti-pilling aids, etc well-known per se.

In preferred methods of the invention, the washing step is undertaken at a detergent product wash liquor concentration in the range from about 0 to about 2% by weight, preferably from about 0 to about 1% by weight, more preferably from about 0 to about 0.5% by weight, and especially from about 0% to about 0.25% by weight. Typically, however, the detergent product will be present in a cleaning-effective amount, i.e. an amount effective to improve the cleaning end-result over and above the end-result that can be achieved in the absence of detergent. Accordingly, the detergent product will normally be present in a level of at least 0.1% by weight of the wash liquor. Suitably the wash liquor pH during the washing step is in the range from about 5 to about 13, preferably from about 6 to about 12, more preferably from about 7 to about 11. In methods comprising the use of detergency enzymes such as proteases, cellulases and amylases, the enzyme concentration during the washing step is preferably from about 0.0001 to about 100 ppm of active enzyme. A non-limiting list of enzymes suitable for use herein is disclosed in, for example, U.S. 2002/0155971.

In a preferred application of the invention, the washing zone herein takes the form of a so-called ‘high efficiency’ washing zone, i.e a washing zone that is designed for contacting and washing the soiled substrate with wash liquor under high efficiency wash conditions. In particular it has been found herein that the combination of water softening with high efficiency wash conditions and wash liquor cleanup and recycle is particularly valuable for providing improved cleaning, stain removal and whiteness maintenance of substrates including across the range of detergent usage levels.

As used herein, the terms ‘high efficiency washing step’, ‘high efficiency wash conditions’ and ‘high efficiency washing zone’ refer to the level of cleaning performance delivered by the washing system as the result of normal mechanical agitation processes within the washing zone. In other words, this excludes the contribution to cleaning performance resulting from chemical, electrochemical or photochemical processes, from high energy mechanical processes such as ultrasonics or cavitation techniques, or from water cleanup and recycling processes involving filtration and the like. The level of cleaning due to mechanical processes is sometimes referred to herein as the ‘mechanical action’ of the washing zone. The mechanical action of a washing zone depends upon many different parameters including 1) machine parameters, for example the type of washing machine, whether the machine is a horizontal or vertical axis machine, the number of drums, the size, shape and baffle arrangement of the drums, the use of secondary low pressure spray systems, etc; and 2) operational parameters dependent upon cycle selection, for example the rotational speed and rotational pattern of the drums, the power consumption of the wash process, the water level, the rate and pattern of movement through the wash liquor, the number of drum revolutions/cycle, etc. As used herein, the mechanical action of the washing zone is quantified in terms of the stain removal performance delivered in a nil-detergent context using a set of standard stained cotton swatches under certain usage conditions. In particular a ‘high efficiency’ washing zone is defined herein as a washing zone which delivers or is capable of delivering a minimum level of mechanical action in one or more cool temperature (20° C. to 40° C.) main wash cycles of the washing system. Fabrics that are laundered in the washing zone are said to be subject to high efficiency wash conditions. The minimum level of mechanical action required herein for high efficiency corresponds to at least about 47% stain removal under test conditions as described hereinbelow. In preferred embodiments, the mechanical action is set at somewhat higher levels in the range from about 50% to about 65%, more preferably from about 53% to about 60% stain removal, the upper limits being set by fabric care considerations.

The stain removal test conditions are as follow:

EMPA 101-104 stain set—pure woven cotton swatches stained with particulate (carbon black/mineral oil), enzymatic (blood), greasy (chocolate/milk) and bleachable (red wine) soils according to IEC 60456 Edition 4, Annex E; 8 replicates per appliance; ballast load—3 kg clean laundry; water hardness—6 degrees English Clark; data analysis via image analysis calibrated vs MacBeth 24 Chip Color Chart; stain removal increase (SRI) averaged over the stain set.

Sonics

In another application of the invention, the washing systems herein additionally comprise means for sonically or ultrasonically treating the soiled substrate in the washing zone or in a washing pre-treatment zone. In particular it has been found herein that the combination of sonic or ultrasonic treatment with wash liquor cleanup and recycle and water-softening is particularly valuable for providing improved cleaning of substrates across the range of detergent usage levels. Preferably the means for sonically or ultrasonically treating the soiled substrate comprises a sonic or ultrasonic energy generator or a plurality of such generators wherein the frequency of the generated energy is in the range from about 1 kHz to about 150 kHz, preferably from about 20 kHz to about 80 kHz and the power input to the generator is in the range from about 0.1 W to about 500 W, preferably from about 10 W to about 250 W.

In one embodiment, the energy generator is adapted for generating and supplying ultrasonic energy to the soiled substrate within the washing zone. In such an embodiment, the frequency of the generated energy is preferably in the range from about 20 kHz to about 150 kHz, more preferably from about 20 kHz to about 80 kHz, and the power input to the generator is preferably in the range from about 20 W to about 500 W per gallon of wash liquor (5.28 W to 132.1 W per litre), more preferably from about 25 W to about 250 W per gallon of wash liquor (6.6 W to 66.1 W per litre) in the washing zone. An energy generator suitable for use in such embodiments comprises an ultrasound transducer and an electronic power supply. The ultrasound transducer can be either a PZT (Lead-Zirconate-Titanite) transducer or a magnetostrictive transducer. Examples of the commercial ultrasound transducers include Vibra-Cell VCX series from Sonics & Materials Inc, and Tube Resonator from Telsonic AG. Single or array of several transducers can be used in the washing system. The transducer(s) can be mounted at the bottom or on the sidewall surrounding the washing zone. It can also be submersed directly in the washing zone. The transducers can also be mounted within the washing machine drum or tub as described in detail below.

In a preferred embodiment of this type, the washing system takes the form of a front-loading washing machine comprising a drum for accommodating the laundry, the drum having one or more, preferably two to four, more preferably three baffles on the inner circumferential wall thereof for tumbling the laundry. The washing machine also comprises one or more sonic or ultrasonic generators mounted on at least one and preferably on each baffle of the drum so that sonic or ultrasonic energy is applied to the laundry as the laundry items are lifted out of the bulk wash liquor in contact with the corresponding baffle. In another embodiment of this type, the washing system takes the form of a top-loading washing machine having a central agitator paddle having one or more sonic or ultrasonic generators mounted thereon.

In an alternative embodiment, the energy generator is adapted for generating and supplying sonic or ultrasonic energy to the soiled substrate within the washing pre-treatment zone. In such an embodiment, the frequency of the generated energy is preferably in the range from about 1 kHz to about 80 kHz, more preferably from about 20 kHz to about 60 kHz, and the power input to the generator is preferably in the range from about 0.1 W to about 80 W, more preferably from about 1 W to about 40 W. An energy generator suitable for use in such embodiments comprises one or more vibrating cleaning transducers adapted to physically contact one or more surfaces of the soiled substrate. In use, the soiled substrate is passed under or between the cleaning transducers, the substrate being simultaneously or previously wetted with wash liquor. The cleaning transducer can be mounted in a convenient position outside the washing zone and provided with means to enable drainage of the wash liquor into the washing zone.

The systems and methods of the invention can also include embodiments that combine the energy generator for the washing zone and the energy generator for the washing pre-treatment zone with frequencies and power inputs as described above.

Electrolysis Zone

In a further application of the invention, the washing systems herein additionally comprise an electrolysis zone for electrolysing the feed water or wash liquor for purposes of generating electrolytically-activated wash liquor and/or rinse liquor. In particular it has been found herein that the combination of electrolysis with wash liquor cleanup and recycle and water-softening is particularly valuable for providing improved cleaning of substrates across the range of detergent usage levels. The electrolysis zone herein preferably comprises electrolysis means provided with at least a pair of electrodes for electrolysing the feed water or wash liquor, the electrolysis means being referred to respectively as feed water electrolysis means and wash water electrolysis means. Generally the feed water electrolysis means is disposed intermediate the feed supply and washing zone, while the wash liquor electrolysis means is disposed within the washing zone or within the wash liquor recycle zone. A combination of feed water and wash liquor electrolysis means is also envisaged herein. Optionally, the electrolysis zone can also comprise a reservoir (the electrolysis reservoir) for storage of the resulting electrolysed water, and means for storage and dispensing of electrolyte or other oxidant-precursor species into the feed water or wash liquor.

In terms of function, electrolysis zones suitable for use herein include both oxidant-generating and pH-generating electrolysis zones. In oxidant-generating embodiments of the invention, the feed water or wash liquor comprises in use one or more oxidant-precursor species and the electrolysis zone comprises means for generating one or more streams of oxidant or mixed-oxidant species in the feed water or wash liquor by electrolysis of the oxidant-precursor species.

In pH-generating embodiments of the invention, the electrolysis zone comprises means for generating one or more streams of acidic and/or alkaline species in the feed water or wash liquor, said one or more streams being supplied to the washing zone for use in the substrate washing step or in a subsequent substrate rinsing step.

By ‘electrolytically-activated wash liquor’ is meant wash liquor that has been subjected to electrolysis, e.g. to generate oxidant, mixed oxidant, acidic or alkaline species, or wash liquor derived from feed water that has been subjected to electrolysis. The term ‘electrolytically-activated rinse liquor’ on the other hand refers to rinse liquor derived from feed water or wash liquor that has been subjected to electrolysis.

In one embodiment, the electrolysis unit is utilized in combination with the capacitive deionization unit to generate bleaching species capable for use as stain removers and for sanitization. In such an embodiment, the waste stream from the capacitive deionization unit is routed to the electrolysis unit. Without wishing to be bound by theory, it is believed that the waste stream from the capacitive deionization unit contains a high level of cationic and/or anionic species. The cationic and/or anionic species within the waste stream, upon electrolysis, are converted to various bleaching species including, but not limited to, hypochlorite, chlorine dioxide, and combinations thereof. It is believed that the majority of bleaching species are in the acid stream. The bleaching species generated are routed to the washing zone. Without wishing to be bound by theory, it is believed that the acid stream, when sent to the washing zone, in the washing zone acts as an antimicrobial in the washing zone. Further, it is believed that the base stream, when sent to the washing zone, acts to raise the pH to improve cleaning. Further the acid stream and/or base stream could be recombined and still deliver a bleaching effect in the wash zone or the one or both streams could be sent to the waste.

In another embodiment, the acid stream and/or the base stream from the electrolysis unit is used to clean and/or regenerate the neutral species from the electrodes and/or other units. In such an embodiment, the electrolysis unit is used to generate an acid stream and/or a base stream. Without wishing to be bound by theory, it is believed that any neutral metal species located on the electrodes will react when contacted by the acid stream while any neutral organic species will react when contacted by the base stream. After contact with the acid and/or the base stream, the neutral metal species and/or the neutral organic species become soluble. Upon solublization, the reacted neutral metal species and the neutral organic species optionally can be expelled as a waste electrode stream out of the capacitive deionization unit.

In yet another embodiment, the acid stream and/or the base stream can be used to clean various units in connection with the current invention. In one non-limiting example, the acid stream and/or the base stream is used to clean a cross-filtration unit. Without wishing to be bound by theory, the acid stream and/or the base stream is brought into contact with the surface of the membranes of the cross flow filtration unit. Upon contact, the acid stream and/or the base stream reacts and/or dissolves species located on the membrane, thus providing cleaning.

Disinfection Zone

In another application of the invention, the washing systems herein additionally comprise a wash liquor disinfection zone. In particular it has been found herein that the combination of wash liquor disinfection with wash liquor cleanup and recycle and water-softening is particularly valuable for providing improved cleaning of substrates across the range of detergent usage levels.

The disinfection zone can take a number of different forms. In a first embodiment, the disinfection zone comprises an antibacterial agent (which term herein includes both bactericidal and bacteriostatic agents) and means for delivering the antibacterial agent to the wash liquor. Preferably the antibacterial agent comprises one or more oxidant or bleaching species such as ozone, hypochlorous acid or one or more antibacterial metal ion sources inclusive of silver, copper, zinc, tin and compounds thereof as well as combinations of said antibacterial ion sources with inorganic carrier materials. In a preferred embodiment of this type, the disinfection zone comprises an electrolytic source of an antibacterial agent such as silver, copper, zinc or tin ions or of an active oxidant or bleaching species such as hypochlorous acid. In another embodiment, the disinfection zone comprises a photocatalyst and/or UV source. In such embodiments, the photocatalyst and/or UV source can be associated with an ultrafiltration or microfiltration device for purposes of cleaning and disinfecting both the filtration device and the wash liquor. The washing systems of the invention are exemplified as follows.

### EXAMPLES

### Example 1

A filtration device suitable for use in the washing systems of the invention takes the form of a module as described in general terms hereinabove. The module comprises a filter housing provided with a membrane compartment in which a series of six intercommunicating membrane subunits is mounted, each subunit comprising a bundle of 12 tubular membranes each of about 1.04 m length with a lumen size of about 3 mm providing a total path length of about 75 metres and a total surface area of about 0.5 m². The tubular membranes are made of an asymmetric polyethersulphone membrane material and have a nominal pore size of about 0.1 μm, a pore size ratio (inner to outer surface) of about 1:10, a surface energy (inner surface) of about 8 dynes/cm, and a Reynold's Number of about 4000 at an operating pressure of 100 kP (1 bar). The device has a clean water flux of about 3000 L/m²h at 100 kp (RO water at 25° C.) and a pressure drop of about 50 kP (0.5 bar) The filtration device is used in conjunction with an appliance comprising a zone for softening the feed liquor. The appliance takes the form of a front-loading washing machine comprising a drum for accommodating the laundry (washing zone) and which has a plurality of holes in its circumferential wall. The drum is mounted for rotation about a horizontal axis within an outer tub and a drive unit is provided for rotating the drum in forward/reverse directions. Three baffles are ranged equidistantly on the inner circumferential wall parallel to the axis of rotation to provide a tumbling action to the laundry. The drive unit comprises a motor, a motor pulley mounted on the output shaft of the motor, a horizontal drive shaft for the drum extending through the rear wall of the outer tub and rotatably supported by a bearing, a drive pulley mounted on the horizontal shaft, and a drive belt connecting the two pulleys. The appliance also comprises the usual product dispensing, pump, suspension, power, program, heating and temperature control means, etc.

The filtration device is provided with wash liquor input and permeate and retentate outlet ports, the permeate outlet being in fluid communication with the drum of the washing machine and the retentate outlet port being in fluid communication with a holding vessel of 10 litres capacity vented to atmosphere and which acts as wash liquor buffer zone.

The water softening zone is disposed between feed supply and the washing zone and comprises an electrodeionization device marketed by Sabrex under the trade name Mini EWP.

The system is used for washing a typical load of soiled laundry either in the absence of detergent or in conjunction with either a liquid or bleach-containing granular detergent (Ariel Futur) at concentrations in the range from 0.1-0.5 wt %. Wash liquor cleanup and recycling is initiated together with disinfection treatment prior to delivery of detergent and again at a point approximately 60% through the main wash cycle. The system and method of Example 1 provides improved cleaning of soiled laundry across the range of detergent usage levels.

### Example 2

A capacitive deionization unit is fluidly connected to the inlet water stream for a washing machine or in the recycle loop of a washing machine. The electrolysis unit is fluidly connected to the capacitive deionization unit, where feed water enters into the electrolysis unit, and the electrolysis unit generates an acid and a base stream from the feed water. An additional feedback loop is connected from the capacitive deionization waste stream to the inlet of the electrolysis unit, where both electrolysis feed water options would be able to shunt the acid water stream to the capacitive deionisaation electrodes or the wash tub or to a small bleach storage tank. The base stream would be able to shunt its water into the wash tub or to a small storage tank.

The acid storage tank would be able to deliver highly concentrated bleach to the wash tub at any point, including the rinse cycle—where surfactants & enzymes have been removed. The enzyme and surfactants are removed by passing them through a cross-flow filter with molecular weight cutoffs specific to the species to be retained. For example, a 100,000 MW cutoff to retain enzymes and a second filter with a cutoff of 1,000 MW to retain the surfactants. (prevents enzyme degradation during the wash step by removing them prior to adding the bleach from the electrolysis step). Additionally, the base holding tank would be able to shunt its water into the wash tub at any point during the wash/rinse cycle, preferably during the initial wash step.

1. A washing system for use in cleaning or washing a substrate comprising:
a. a washing zone capable of containing a substrate; and
b. a water-softening zone fluidly connected to the washing zone;
wherein the water-softening zone is capable of receiving a feed water and forming an at least partially softened water and wherein the water-softening zone is capable of fluidly transferring at least part of the at least partially softened water to the washing zone.

2. The washing system of claim 1, wherein the washing zone is capable of cleaning or washing substrates comprises laundry and dishware

3. The washing system of claim 1, wherein the water softening zone comprises nanofiltration devices, electrodeionization devices, electrodialysis devices, reverse-osmosis devices capacitive deionization devices, and ion-exchange water-softening devices and combinations thereof.

4. The washing system of claim 5, wherein the water-softening zone is a capacitive deionization device.

5. The washing system of claim 1, wherein the at least partially softened water comprises a residual Ca²⁺ hardness of less than about 4 mmol/L.

6. The washing system of claim 1, wherein at least partially softened water comprises a soft water flux of at least about 2 L/h at a feed water pressure from about 100 to about 1000 kP.

7. The washing system of claim 1, further comprising at least one of
a. a washing pre-treatment zone fluidly connected to the washing zone;
b. a sonic treating zone or an ultrasonic treating zone, each capable of treating a substrate in the washing zone or in the washing pre-treatment zone; and
c. an electrolysis zone capable of electrolyzing the feed water or the at least partially softened water fluidly connected to the washing zone.

8. The washing system of claim 1, wherein the washing zone is capable of utilizing a detergent.

9. The washing system of claim 1, wherein the washing zone and the water-softening zone are housed substantially within one housing.

10. The washing system of claim 1, wherein the washing zone and the water-softening zone are independently housed.

11. The washing system of claim 1, further comprising a prefilter.

12. A process for cleaning or washing a substrate comprising the steps of:
a. providing a washing system, said system comprising a washing zone capable of containing a substrate; and a water-softening zone fluidly connected to the washing zone;
wherein the water-softening zone is capable of receiving a feed water and forming an at least partially softened water and
wherein the water-softening zone is capable of fluidly transferring at least part of the at least partially softened water to the washing zone
b. placing a substrate with the washing system
c. flowing the feed water into the water-softening zone
d. engaging the water-softening zone to form the at least partially softened water
e. transferring at least part of the at least partially softened water into the washing zone and
f. optionally, adding a detergent to the washing zone.

13. The process of claim 12, wherein the washing zone is capable of cleaning or washing substrates selected from laundry or dishware.

14. The process of claim 12, wherein the water softening zone comprises nanofiltration devices, electrodeionization devices, electrodialysis devices, reverse-osmosis devices capacitive deionization devices, and ion-exchange water-softening devices and combinations thereof.

15. The process of claim 14, wherein the water-softening zone is a capacitive deionization device.

16. The process of claim 12, wherein the at least partially softened water comprises a residual Ca²⁺ hardness of less than about 4 mmol/L.

17. The process of claim 12, wherein the washing system further comprising at least one of
a. a washing pre-treatment zone fluidly connected to the washing zone;
b. a sonic treating zone or an ultrasonic treating zone, each capable of treating a substrate in the washing zone or in the washing pre-treatment zone; and
c. an electrolysis zone capable of electrolyzing the feed water or the at least partially softened water fluidly connected to the washing zone.

18. A washing system for use in cleaning or washing a substrate comprising:
a. a washing zone capable of containing a substrate; and
b. a water-softening zone, and
c. an electrolysis zone wherein the water-softening zone is capable of directing at least a partially softened water to the washing zone, the electrolysis zone, or combinations thereof, and wherein the water-softening zone is capable of directing a waste electrolyte stream to the electrolysis zone, and wherein the electrolysis zone is capable of directing an acid stream and/or a base stream to the washing zone, the water-softening zone or combinations thereof.

19. The washing system of claim 18, wherein the water-softening zone is a capacitive deionization unit.

20. The washing system of claim 18, wherein the acid stream is fluidly connected to the water-softening zone.

21. The washing system of claim 18 wherein the waste electrolyte stream is fluidly transported to the water-softening zone.
